(19) United States
(12) Patent Application Publication
(10) Pub. No.: US 2021/0284111 A1
(43) Pub. Date: Sep. 16, 2021

(54) METHOD AND DEVICE FOR OPERATING A MOTOR VEHICLE, AND MOTOR VEHICLE

(71) Applicant: Robert Bosch GmbH, Stuttgart (DE)

(72) Inventors: Alfred Strehle, Fellbach (DE); Markus Mengelkamp, Bietigheim-Bissingen (DE); Thomas Schmidt, Bietigheim-Bissingen (DE)

(21) Appl. No.: 16/332,568

(22) PCT Filed: Aug. 2, 2017
(86) PCT No.: PCT/EP2017/069511

§ 371 Date: Mar. 12, 2019

(30) Foreign Application Priority Data
Sep. 30, 2016 (DE) 102016218948.4

(51) Int. Cl. B60T 8/1755; B60T 7/12; B60T 8/94

(52) U.S. Cl. CPC B60T 8/17554; B60T 7/12; B60T 8/94; B60T 2250/04; B60T 2220/03; B60T 2270/402; B60T 2201/16

(57) ABSTRACT

A method for operating a motor vehicle which includes a primary braking system and a secondary braking system, each wheel of the motor vehicle being assigned a wheel brake which is actuatable by the braking systems, the secondary braking system being activated during an emergency braking operation in such a way that each of the wheel brakes generates the same brake force. An instantaneous steering angle of the motor vehicle is detected during the emergency braking operation and the secondary braking system is activated as a function of the detected steering angle.

### BACKGROUND INFORMATION

The present invention relates to a method for operating a motor vehicle which includes a primary braking system and a secondary braking system, each wheel of the motor vehicle being assigned a wheel brake which is hydraulically actuatable by the braking systems, and the secondary braking system being activated during an emergency braking operation in such a way that each of the wheel brakes generates the same brake force.

Furthermore, the present invention relates to a device for operating a motor vehicle which includes a primary braking system and a secondary braking system as well as at least one drive unit, each wheel of the motor vehicle being assigned a wheel brake which is hydraulically actuatable by the braking systems, including a control unit which is designed to activate the secondary braking system, in the case of failure of the primary braking system, during an emergency braking operation in such a way that the wheel brakes generate the same brake force.

Furthermore, the present invention relates to a motor vehicle including a corresponding device.

Methods, devices, and motor vehicles of the type mentioned at the outset are already known from the related art. Vehicle braking systems of motor vehicles increasingly fulfill extended functional ranges, such as supporting the driver with the aid of a brake booster which may be designed to work electromechanically or hydraulically, in addition to drive-stabilizing functions which are carried out with the aid of an electronic stability program (ESP) or an anti-lock braking system (ABS), for example. It is also known to activate assisting or partially assisting functions and/or to carry out an active modulation of a hydraulic brake pressure or a hydraulic brake force at the wheel brakes of the vehicle braking system, without the driver actively participating. This makes assistance functions possible which allow for a semi-automated or highly automated brake intervention. Together with a semi-automated or fully automated drive and a semi-automated or fully automated steering of the motor vehicle, a semi or fully autonomous driving operation of the motor vehicle is thus possible.

However, increased demands are made on semi-automated or fully automated functions with regard to their redundancy and failsafe performance. In particular, a backup level is expected in the case that the primary braking system fails. In the present case, the primary braking system or the primary actuator is in particular understood to mean that actuator in the environment of automated or autonomous driving which takes over the stabilizing function for the motor vehicle in the error-free state of the braking system. This is usually the ESP system. The secondary braking system or the secondary actuator is correspondingly to be understood to mean that actuator which takes over at least to a certain extent the stabilizing task, in particular the longitudinal stabilizing, if the primary braking system fails. One exemplary implementation of an overall braking system, which includes a primary and a secondary actuator, is, for example, the EPS as the primary braking system and an electronic brake booster as the secondary braking system. A corresponding primary braking system is described in German Patent Application No. DE 10 2009 001 135 A1, for example. The secondary braking system, if it includes an electromechanical brake booster, is, for example, also connected to the brake master cylinder and is used to increase the driving comfort during normal operation by supporting the driver with building up a brake pressure which is necessary for the braking action. The brake booster provides, if necessary, a brake force, which is used to support the driver, for actuating the brake master cylinder. The primary braking system and the secondary braking system thus form two braking systems, which are redundant with regard to one another, for generating and modulating a brake pressure. If the primary braking system, which is usually capable of adjusting wheel-individual braking torques or brake forces, fails, the secondary braking system is expected to at least still be capable of carrying out measures for longitudinal stabilization through active or passive pressure modulation, for example. In this case, the requirements are already met by a secondary braking system which adjusts the same braking torque or the same brake force at all wheel brakes during the emergency braking operation. This means that for the emergency braking operation the brake forces are usually not predefined individually for each wheel and merely a hydraulic pressure is generated which acts identically upon all wheel brakes, which is why this process is also referred to as a one-channel brake force generation. One demand on the longitudinal stabilization using the secondary braking system is that the vehicle must still be steerable.

### SUMMARY

An example method according to the present invention may have the advantage that the lateral cornering forces necessary to stabilize the motor vehicle are ensured or that the assurance, that a steering input of the driver or of a superimposed system of the autonomously driving motor vehicle is met, is enhanced by simple means. With the aid of the method according to the present invention, it is achieved that despite the one-channel brake force generation, a steering input is taken into account in such a way that there is a preferably minor deviation between a setpoint trajectory and an actual trajectory of the motor vehicle and thus the maneuverability of the motor vehicle is also improved during the emergency braking operation, i.e. in the case of a deceleration demand on the secondary braking system. This is achieved according to the present invention in that an instantaneous steering angle of the motor vehicle is detected during the emergency braking operation and the secondary braking system is activated as a function of the detected steering angle. During the emergency braking operation, the generation of the brake force is thus influenced with knowledge of the steering angle. It is thus achieved that sufficiently high lateral cornering forces are ensured which allow for the motor vehicle to be steered safely and reliably. The present invention in particular provides that the lateral cornering forces are prioritized compared to the longitudinal guiding forces, so that a maximally possible deceleration of the motor vehicle may be neglected for the benefit of an improved maneuverability of the motor vehicle.

Particularly preferably, it is provided that an instantaneous speed of the motor vehicle is detected during the emergency braking operation and the secondary braking system is also activated as a function of the detected instantaneous speed. By taking into account the driving speed and the steering angle, the lateral cornering force which is transferable by the particular wheel may be determined and thus an optimal activation of the secondary braking system is made possible. The steering angle and the influence on the secondary braking system as a function of the steering angle are preferably additionally used in methods which ensure that the wheels of the front wheel axle and of the rear wheel axle adhere to a desired locking sequence and ensure the longitudinal stabilization. For the purpose of determining the lateral cornering force, any arbitrary speed of the motor vehicle may be detected, such as the wheel speed or the vehicle longitudinal speed.

It is in particular provided that the brake force to be adjusted is determined with the aid of the Kamm circle. The Kamm circle puts the lateral longitudinal guiding forces in proportion to the lateral cornering forces of a wheel, so that with knowledge of the steering angle the brake force to be maximally adjusted is readily ascertainable with the aid of the Kamm circle.

Furthermore, it is preferably provided that the adjusted brake force is reduced with an increasing steering angle. To maintain the driving stability and stay true to the trajectory of the motor vehicle, the brake force or the hydraulic pressure must be reduced with an increasing necessary lateral cornering force. This is advantageously achieved by taking into account the increasing steering angle and the thus resulting reduction of the brake force.

Furthermore, it is preferably provided that an actual steering angle between a vehicle longitudinal axis of the motor vehicle and a longitudinal axis of a steerable wheel of the motor vehicle is detected as the steering angle. This may take place with the aid of suitable sensors, for example, which are assigned to the wheel. In this way, the steering angle is precisely detectable and, in particular, does not even depend on a setpoint steering angle which may be implemented incorrectly, for example, as a result of a roadway condition, a mechanical defect, or the like.

Alternatively, it is preferably provided that a setpoint steering angle which is predefinable by a steering handle, in particular a steering wheel, of the motor vehicle, is detected as the steering angle. This has the advantage that the detection of the steering angle may be carried out more easily since no additional sensors are necessary therefor. The setpoint steering angle is already monitored by sensors in the motor vehicle in any case, so that it is readily available to carry out the presented method. This is even easier if the setpoint steering angle is predefined by the motor vehicle itself during the autonomous driving operation. Furthermore, it is preferably provided that both the actual steering angle and the setpoint steering angle are detected as the steering angle. Here, the setpoint steering angle may be checked for plausibility, for example, with the aid of the detected actual steering angle or the correct adjustment of the steering angle may be confirmed as a function of the setpoint steering angle.

Furthermore, it is preferably provided that during the emergency braking operation the brake force is adjusted to be oscillating at least from time to time. It is thus achieved that the brake force is increased and reduced on a regular basis and thus obtains an oscillating characteristic. As a result of this pressure modulation, a maximum brake force is safely detectable starting from which the braked wheel starts to lock. The brake force to be adjusted is correspondingly adjusted as a function of the detected maximum brake force, so that the maximum brake force is not exceeded. A friction coefficient (μ value)−between the particular wheel and the roadway—which is necessary for computing the lateral cornering force is preferably ascertained with the aid of this one-channel pressure modulation and as a function of the extent of the adjusted deceleration or by estimation and/or with the aid of sensors, friction coefficient maps or the like, prior to a curve negotiation being initiated by adjusting a steering angle. This type of friction coefficient determination is known in general and is therefore not to be elucidated in greater detail at this point. If the pressure braking operation does not take place until the curve negotiation, the most recently determined friction coefficient is preferably used or a friction coefficient is estimated.

An example device according to the present invention provides that the control unit is specially configured to carry out the method according to the present invention when used according to its intended purpose. This yields the advantages already mentioned above.

An example motor vehicle according to the present invention includes the device according to the present invention. This also yields the already mentioned advantages.

Below, the present invention is described in further detail with reference to the figures.

### BRIEF DESCRIPTION OF THE DRAWINGS

FIG. 1 shows a motor vehicle in a simplified top view.

FIG. 2 shows a simplified method for operating the motor vehicle.

FIG. 3 shows a brake force-time-diagram to explain an advantageous method for operating the motor vehicle.

### DETAILED DESCRIPTION OF EXAMPLE EMBODIMENTS

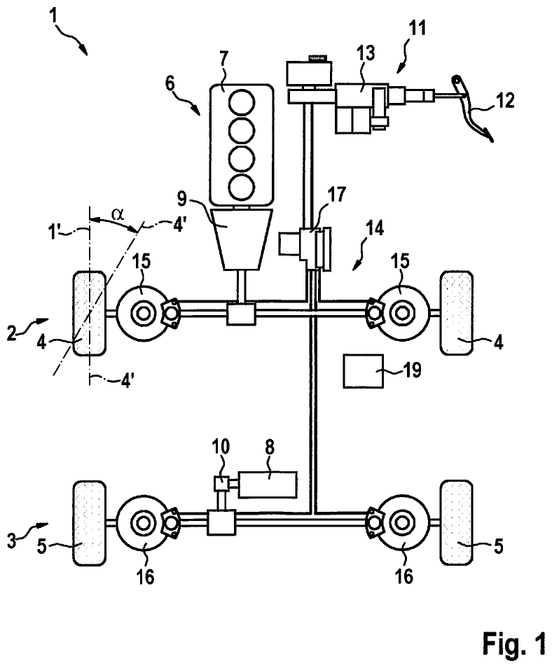

FIG. 1 shows a simplified top view of a motor vehicle 1. Motor vehicle 1 includes a front wheel axle 2 and a rear wheel axle 3 each of which has two wheels 4 and 5, respectively, which are in contact with the roadway for the purpose of subjecting motor vehicle 1 to an acceleration torque or a deceleration torque.

In order to accelerate vehicle 1, the latter includes a drive system 6 having two drive units 7 and 8 in the present case. First drive unit 7 is designed as an internal combustion engine and is or may be operatively connected to wheels 4 of wheel axle 2 through a transmission 9 and a clutch (not illustrated). Second drive unit 8 is designed as an electric machine which is operatively connected to wheels 5 of rear wheel axle 3 through a transmission 10. Drive units 7 and 8 may thus be used to generate different positive or negative torques to be applied to wheel axles 2 and 3. Motor vehicle 1 may also include only one of drive units 7, 8.

In order to decelerate motor vehicle 1, the latter includes a vehicle braking system including a brake pedal 12 which is actuatable by the driver and which is connected to an electromechanical brake booster 13 which boosts the foot power applied to brake pedal 12 and converts it into a hydraulic pressure of a primary braking system 14. Primary braking system 14 includes hydraulically actuatable wheel brakes 15 and 16 for each of wheels 4 and 5, respectively. In order to hydraulically actuate wheel brakes 15, 16, primary braking system 14 includes an ABS/ESP module 17 which controls the hydraulic pressure individually for each wheel and thus allows for a wheel-individual brake force adjustment. In this case, module 17 may intervene to stabilize the vehicle, for example, and may apply a brake force to individual wheels 4, 5, to maintain the driving stability of motor vehicle 1 in a critical driving situation.

Furthermore, the vehicle braking system includes a secondary braking system 11 which is also designed to work hydraulically in the present exemplary embodiment and which is activated when primary braking system 14, in particular module 17, fails. Secondary braking system 11 uses brake booster 13 as the actuator. In this case, the hydraulic pressure in the brake circuit which is adjusted with the aid of electromechanical brake booster 13 in an automated manner is variable, but it is distributed equally among wheel brakes 15, 16 due to failure of module 17, so that the same brake force is adjusted at all wheel brakes 15, 16. As a result, the longitudinal stabilization of motor vehicle 1 is carried out in an automated manner or in a semi-automated manner even in the case of failure of primary braking system 14.

A control unit 19 which is, for example, a control unit of the vehicle braking system, in particular of electromechanical brake booster 13, monitors the operability of primary braking system 14 during the operation of the motor vehicle. If control unit 19 establishes that primary braking system 14 functions erroneously or no longer functions at all, it is fully deactivated by control unit 19 and secondary braking system 11 is instead activated to decelerate motor vehicle 1 in a longitudinally stabilized manner.

Secondary braking system 11 increases the hydraulic pressure at all wheel brakes 15, 16 or hydraulically adjusts a brake force with the aid of electromechanical brake booster 13. As already explained above, the resulting brake force is the same at all wheels 4, 5.

According to the present exemplary embodiment, wheels 4 of wheel axle 2 are designed to be steerable. For this purpose, longitudinal axis 4′ is plotted as a dashed line at one of wheels 4 in FIG. 1 during a curve negotiation. During the curve negotiation, an angle results between longitudinal axis 4′ of wheel 4 and a vehicle longitudinal axis 1′ which is also plotted in FIG. 1 as a dashed line. This angle is referred to in the following as the steering angle a of motor vehicle 1. There are different ways to ascertain steering angle α. It is conceivable, for example, to assign wheel 4 a sensor system which detects the instantaneous actual steering angle of wheel 4. Alternatively, a setpoint steering angle which is predefined by the driver or by the motor vehicle itself, during autonomous driving operation, may be ascertained and established as steering angle α.

Control unit 19 is designed to adjust the brake force or the hydraulic pressure with the aid of secondary braking system 11 as a function of this steering angle α.

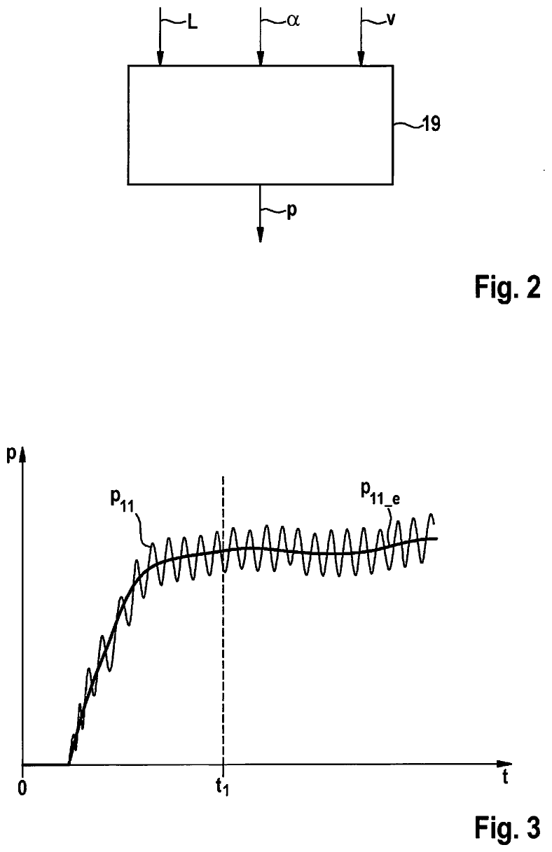

For this purpose, FIG. 2 shows a simplified illustration of the advantageous method for operating motor vehicle 1 in which control unit 19 receives as input signals a piece of information about the vehicle longitudinal deceleration, such as in particular setpoint deceleration L, steering angle α as well as a piece of information about instantaneous vehicle velocity v. As a function of these input signals, control unit 19 ascertains target pressure p which is to be adjusted by secondary braking system 11, in particular with the aid of electromechanical brake booster 13, in order to generate the desired brake force at wheel brakes 15, 16.

During the emergency braking operation, i.e. when primary braking system 14 has failed, instantaneous steering angle a of motor vehicle 1 is taken into account when determining the brake force or when activating secondary braking system 11. With the aid of the Kamm circle, in particular, the lateral cornering force or the lateral cornering forces of wheels 4 is/are determined as a function of steering angle α. For this purpose, the driving speed of the motor vehicle as well as a friction coefficient between wheels 4 and the roadway is taken into account. The friction coefficient or μ value is preferably ascertained prior to initiating the curve negotiation with the aid of a one-channel pressure modulation in which the brake force or the hydraulic pressure is adjusted to be oscillating in order to ascertain on the basis of the thus resulting overall vehicle reaction what torque the wheels of the motor vehicle are capable of generating or whether the wheels lock, for the purpose of determining the instantaneous friction coefficient therefrom. Methods of this type are conventional in general so they will not be discussed in greater detail at this point. The lateral cornering force of wheels 4 which is transferable from wheels 4 to the roadway may be determined as a function of the friction coefficient, vehicle velocity v as well as steering angle α.

Control unit 19 now activates secondary braking system 11 in such a way that the adjusted brake force ensures that the lateral cornering force, which allows for motor vehicle 1 to be steered during deceleration, is maintained during deceleration. In this way, the driving stability of motor vehicle 1 is also reliably ensured during a curve negotiation during the emergency braking operation.

If the friction coefficient has not been ascertained prior to initiating the curve negotiation, it is preferably estimated, for example on the basis of previously ascertained friction coefficients, with the aid of sensors, friction coefficient maps or the like. Since the instantaneous actual friction coefficient is unknown during the curve negotiation itself, it may be estimated as a function of the friction coefficient by taking into account the occurrence probability of coupled events (severity classification: coupling of 1, for example; high degree of deceleration and necessary adaptation during curve negotiation: coupling of 2; sudden friction coefficient change during curve negotiation: coupling of 3).

Control unit 19 reduces the hydraulic pressure or the brake force of secondary braking system 11 with increasing steering angle α, in order to ensure the lateral cornering forces of wheels 4 which are necessary in the particular situation.

FIG. 3 shows a possible functional illustration of how steering angle α is taken into account for the one-channel stabilizing function of secondary braking system 11. In the one-channel pressure modulation for longitudinally stabilizing the vehicle, which is based on the overall vehicle longitudinal deceleration information as the stability indicator, stimulation is typically used in a way which makes it possible to evaluate the vehicle reaction. For this purpose, the brake force, as already mentioned above, is in particular adjusted to be oscillating. This is illustrated in FIG. 3 which shows the hydraulic pressure of secondary braking system 11 p₁₁ against time t. Due to the oscillating hydraulic pressure having a defined or predefinable frequency, an effective hydraulic pressure results for stable vehicle deceleration p_{11_e}. As the evaluation criterion, the response to the stimulation on the vehicle level or a sudden deceleration on the motor vehicle level is used, this response being establishable by an acceleration sensor as a sudden longitudinal acceleration of the motor vehicle. By taking into account the stability criteria with regard to the response to the vehicle reaction, mean effective pressure p₁₁₋ₑ is adjusted for stable vehicle deceleration by the one-channel longitudinally stabilizing function with the aid of control unit 19. By taking into account steering angle α and, potentially, vehicle velocity v, effective pressure p_{11_e} is adapted in such a way by adjusting the brake force that the lateral cornering forces may be made available for a curve negotiation. In FIG. 3, this is apparent in that pressure p hardly or no longer increases starting from point in time t₁ at which a curve negotiation is initiated.

The advantageous method described above may be carried out not only on a backup level, when the primary actuator fails, but also when the motor vehicle has no wheel-specific measured variables available for the braking system in general, so that the brake force or the brake pressure adjusted in each case is also affected or predefined as a function of a detected steering angle. This allows for the lateral cornering forces to be improved for one-channel as well as for multi-channel braking systems.

1-9. (canceled)

10. A method for operating a motor vehicle which includes a primary braking system and a secondary braking system, each wheel of the motor vehicle being assigned a wheel brake which is hydraulically actuatable by the primary braking system and the secondary braking system, the secondary braking system being activated during an emergency braking operation in such a way that each of the wheel brakes generates the same brake force, the method comprising:
detecting an instantaneous steering angle of the motor vehicle during the emergency braking operation; and
activating the secondary braking system as a function of the detected steering angle.

11. The method as recited in claim 10, further comprising:
detecting an instantaneous velocity of the motor vehicle in the emergency braking operation, wherein the secondary braking system is also activated as a function of the instantaneous velocity.

12. The method as recited in claim 10, wherein a brake force to be adjusted is determined with the aid of the Kamm circle.

13. The method as recited in claim 12, wherein the adjusted brake force is reduced with increasing steering angle.

14. The method as recited in claim 10, wherein an actual steering angle between a vehicle longitudinal axis of the motor vehicle and a longitudinal axis of a steerable wheel of the motor vehicle is detected as the steering angle.

15. The method as recited in claim 10, wherein a setpoint steering angle which is predefinable by a steering wheel of the motor vehicle is detected as the steering angle (α).

16. The method as recited in claim 10, wherein during the emergency braking operation, the brake force is adjusted to be oscillating at least from time to time.

17. A device for operating a motor vehicle which includes a primary braking system, a secondary braking system, and at least one drive unit, each wheel of the motor vehicle being assigned a wheel brake which is hydraulically actuatable by the primary braking system and the secondary braking system, the device comprising:
a control unit configured to activate the secondary braking system, in the case of failure of the primary braking system, during an emergency braking operation in such a way that the wheel brakes generate the same brake force, the control unit configured to detect an instantaneous steering angle of the motor vehicle during the emergency braking operation, and activate the secondary braking system as a function of the detected steering angle.

18. A motor vehicle, comprising:
a front wheel axle;
a rear wheel axle;
a primary braking system;
a secondary braking system, wherein each wheel of the wheel axles is assigned a wheel brake which is hydraulically actuatable by the primary braking system and the secondary braking system;
at least one drive unit; and
a device including a control unit configured to activate the secondary braking system, in the case of failure of the primary braking system, during an emergency braking operation in such a way that the wheel brakes generate the same brake force, the control unit configured to detect an instantaneous steering angle of the motor vehicle during the emergency braking operation, and activate the secondary braking system as a function of the detected steering angle.
